(19) United States
(12) Patent Application Publication
(10) Pub. No.: US 2010/0148523 A1
(43) Pub. Date: Jun. 17, 2010

(54) Gate Latch

(75) Inventor: Chi-Chih TAI, San Ramon, CA (US)

Correspondence Address: Wheelock Chan LLP, 2880 Zanker Road, Suite 109, San Jose, CA, 95134, US

(73) Assignee: Chi-Chih Tai

(21) Appl. No.: 12/714,276

(22) Filed: Feb. 26, 2010

(51) Int. Cl. E05C 3/06

(52) U.S. Cl. 292/236

(57) ABSTRACT

A reversible and lockable gate latch is disclosed. The gate latch includes a pivotal latch, having a pivotal opening, a first striker bar receiving opening, and a slider lock opening, a back plate having a pivotal support opening, a second striker bar receiving opening, and a slider lock slot, a slider lock configured to slide along the slider lock slot and the slider lock opening, and a striker bar with supporting structure, where the striker bar with supporting structure is used with the pivotal latch, the back plate and the slider lock to control opening and closing of a gate.

### FIELD OF THE INVENTION

The present invention relates to the field of gate latches for gates and fences. In particular, the present invention relates to a reversible gate latch adaptable to be operated by right hand or left hand.

### BACKGROUND OF THE INVENTION

Various types of conventional gate latches have been used to provide a means of securing gates, for example wooden, plastic, fiber glass or metal fence gates and the like. For example in U.S. Pat. No. 5,655,801, the latches are rather elaborate and require many individual components, thus making them expensive and complex. In other example such as U.S. Pat. No. 5,799,990, the latches require many steps to operate, thus making them hard to use.

In addition, many conventional gate latches are constructed specifically for operation by the left hand or alternatively by the right hand. As a result, such designs require stocking of different components than would be required if the same components would be useable by both left and right hand operated gates. Further, where a gate latch is designed specifically to use for only left hand or right hand gates, ordering errors may occur when a wrong gate latch is obtained and need to be replaced, which leads to delays and extra expense. For example in U.S. Pat. No. 7,021,678, even with more complicated components of self fastening gravity gate latch, an elaborated gate latch bracket, a latch striker bar, and a locking bolt gate latch, the gate latch is still unable to be mounted on both left and right sides of the gate.

Therefore, there is a need for a gate latch that can address the above issues of conventional fence gate latches.

### SUMMARY

The present invention relates to a reversible and lockable gate latch. In one embodiment, the gate latch includes a pivotal latch, having a pivotal opening, a first striker bar receiving opening, and a slider lock opening, a back plate having a pivotal support opening, a second striker bar receiving opening, and a slider lock slot, a slider lock configured to slide along the slider lock slot and the slider lock opening, and a striker bar with supporting structure, wherein the striker bar with supporting structure is used with the pivotal latch, the back plate and the slider lock to control opening and closing of a gate.

In another embodiment, a gate latch includes a pivotal latch having a pivotal opening, a first striker bar receiving opening, and a slider lock slot, a back plate having a pivotal support opening, a second striker bar receiving opening, and a slider lock opening, a slider lock configured to slide along the slider lock slot and the slider lock opening, and a striker bar with supporting structure, wherein the striker bar with supporting structure is used with the pivotal latch, the back plate and the slider lock to control opening and closing of a gate.

In yet another embodiment, a method of using a gate latch includes providing a pivotal latch having a pivotal opening, a first striker bar receiving opening, a slider lock opening, a first padlock opening adjacent to the striker bar receiving opening, a second padlock opening adjacent to the slider lock opening, providing a back plate having a pivotal support opening, a second striker bar receiving opening, a slider lock slot, a first padlock opening adjacent to the striker bar receiving opening, a second padlock opening adjacent to the slider lock slot, a third padlock opening adjacent to the striker bar receiving opening, a fourth padlock opening adjacent to the slider lock slot, a pivotal support opening configured to support the pivotal latch to pivot around the pivotal support opening, providing a slider lock configured to slide along the slider lock slot and the slider lock opening, and providing a striker bar with supporting structure, where the striker bar with supporting structure is used with the pivotal latch, the back plate and the slider lock to control opening and closing of a gate.

The method further includes assembling the pivotal latch, the back plate, the slider lock, and the striker bar with supporting structure to be located on the left side of a gate from an inside perspective. The assembling includes aligning the pivotal opening of the pivotal latch to the pivotal support opening of the back plate, aligning the first padlock opening of the pivotal latch to the first padlock opening of the back plate, aligning the second padlock opening of the pivotal latch to the second padlock opening of the back plate, and aligning the slider lock opening of the pivotal latch to the slider lock slot of the back plate.

The method further includes further comprising assembling the pivotal latch, the back plate, the slider lock, and the striker bar with supporting structure to be located on the right side of a gate from an inside perspective. The assembling includes aligning the pivotal opening of the pivotal latch to the pivotal support opening of the back plate, aligning the first padlock opening of the pivotal latch to the third padlock opening of the back plate, aligning the second padlock opening of the pivotal latch to the fourth padlock opening of the back plate, and aligning the slider lock opening of the pivotal latch to the slider lock slot of the back plate.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIGS. 1A-1C illustrate a pivotal latch of a gate latch according to embodiments of the present invention.

FIGS. 2A-2D illustrate a back plate of a gate latch according to embodiments of the present invention.

FIGS. 2E-2H illustrate various pivotal latch and back plate pairs according to embodiments of the present invention.

FIG. 3A-3B illustrate components and assembly of a gate latch to be operated on the left side from an inside perspective according to embodiments of the present invention.

FIGS. 4A-4D illustrate an assembled gate latch to be operated on the left side from an inside perspective according to embodiments of the present invention.

FIG. 5A-5B illustrates an assembled gate latch of FIG. 4 with padlock according to embodiments of the present invention.

FIG. 6A-6B illustrate components and assembly of a gate latch to be operated on the right side from an inside perspective according to embodiments of the present invention.

FIGS. 7A-7D illustrate an assembled gate latch to be operated on the right side from an inside perspective according to embodiments of the present invention.

FIG. 8A-8B illustrates an assembled gate latch of FIG. 7 with padlock according to embodiments of the present invention.

Like numbers are used throughout the figures.

### DESCRIPTION OF EMBODIMENTS

Embodiments of a reversible gate latch are disclosed. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

According to embodiments of the present invention, a gate latch includes a pivotal latch, a back plate, a striker bar with supporting structure, a slider lock, and a spring configured to return the pivotal latch to a closed position. Details of each component are further described in the paragraphs below along with their corresponding figures.

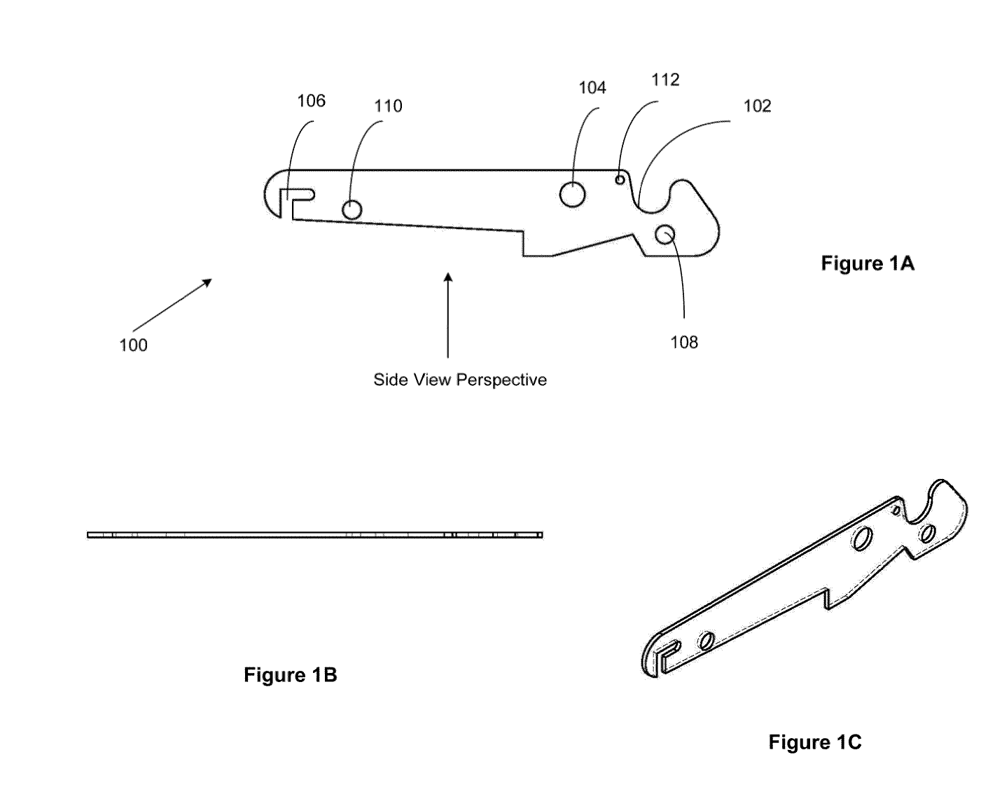

FIGS. 1A-1C illustrate a pivotal latch of a gate latch according to embodiments of the present invention. As shown in FIG. 1A, a pivotal latch 100 includes a striker bar receiving opening 102, a pivotal opening 104, a L-shaped slider lock opening 106, a first padlock opening 108, a second padlock opening 110, and an opening 112. FIG. 1B illustrates a side view of the pivotal latch 100 from the perspective indicated in FIG. 1A, and FIG. 1C illustrates a 3-dimensional view of the pivotal latch 100.

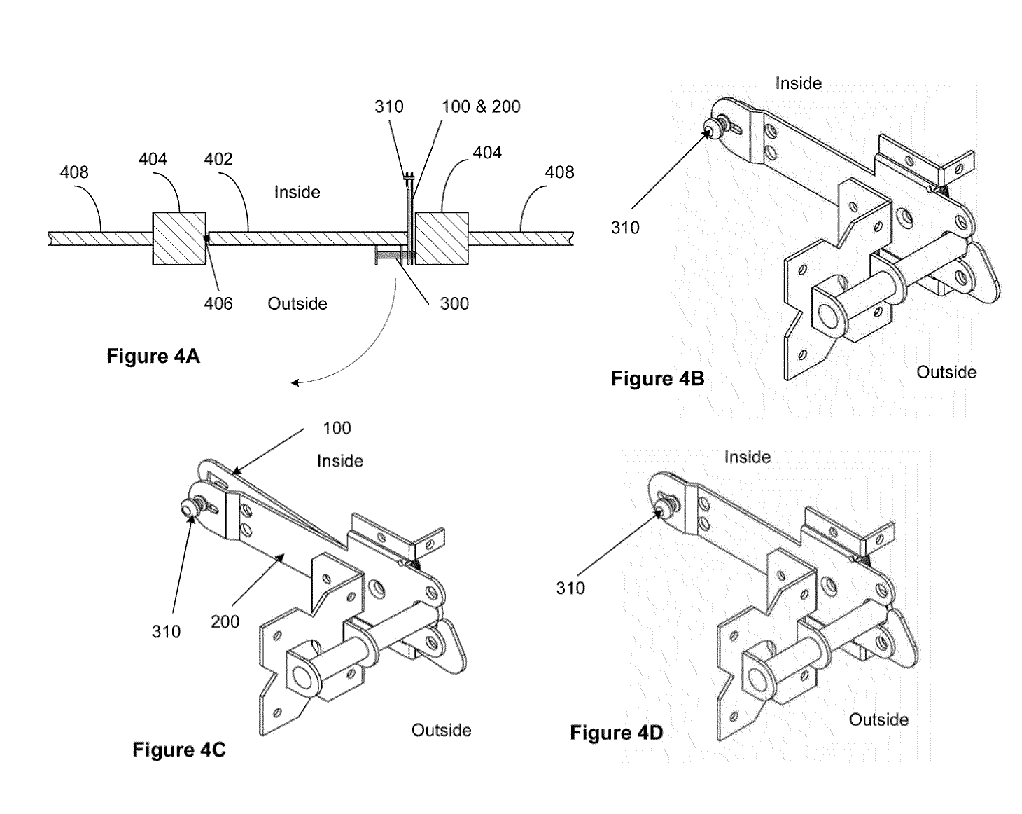

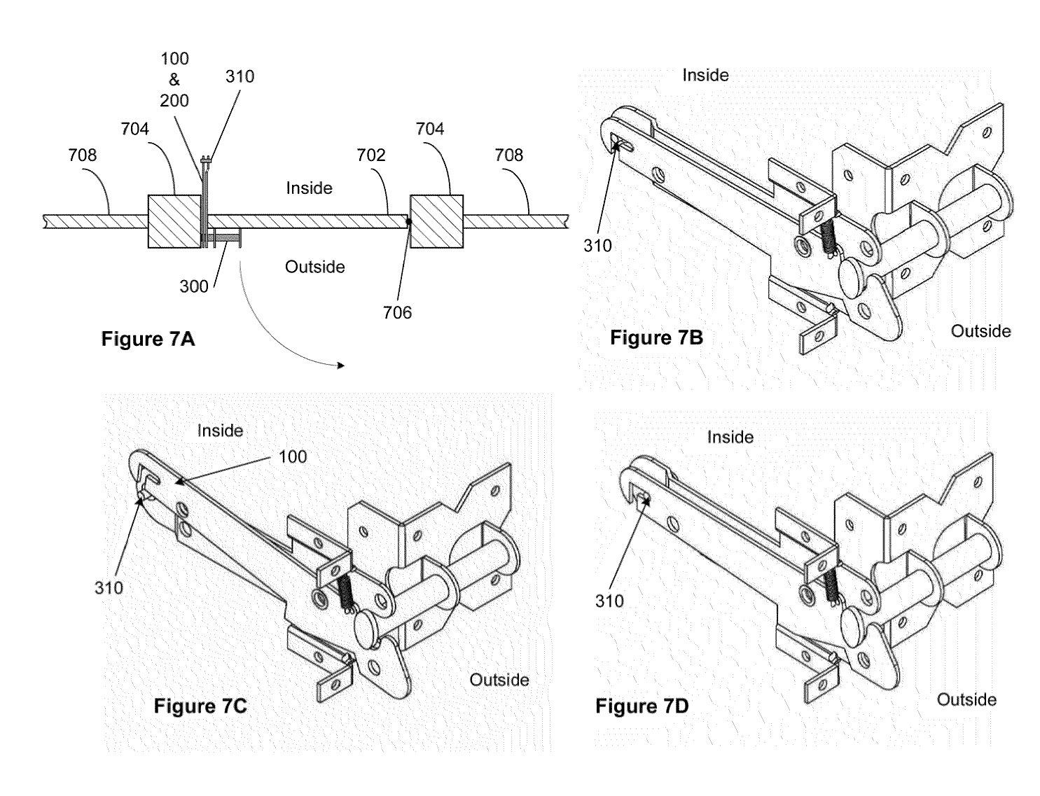

According to embodiments of the present invention, the openings of the striker bar receiving opening 102 and the L-shaped slider lock opening are oriented in opposite direction. As shown in the example of FIG. 1A, the striker bar receiving opening 102 faces in the upward direction while the L-shaped slider lock opening faces in the downward direction. The pivotal opening 104 is used in conjunction with a back plate to allow the pivotal latch to pivot at the position of the pivotal opening 104, and thus allows opening or closing of the gate latch. The L-shaped slider lock opening 106 allows a slider lock to be controlled to lock or unlock the gate latch, which is further described in association with FIGS. 4A-4C and FIGS. 7A-7C.

The first padlock opening 108 is positioned adjacent to the striker bar receiving opening 102, which allows the gate latch to be locked by a padlock from the outside of the fence. On the other hand, the second padlock opening 110 is positioned adjacent to the L-shaped slider lock opening 106, which allows the gate latch to be locked by a padlock from the inside of the fence. The opening 112 is to be used with a spring configured to return the pivotal latch to the closed position.

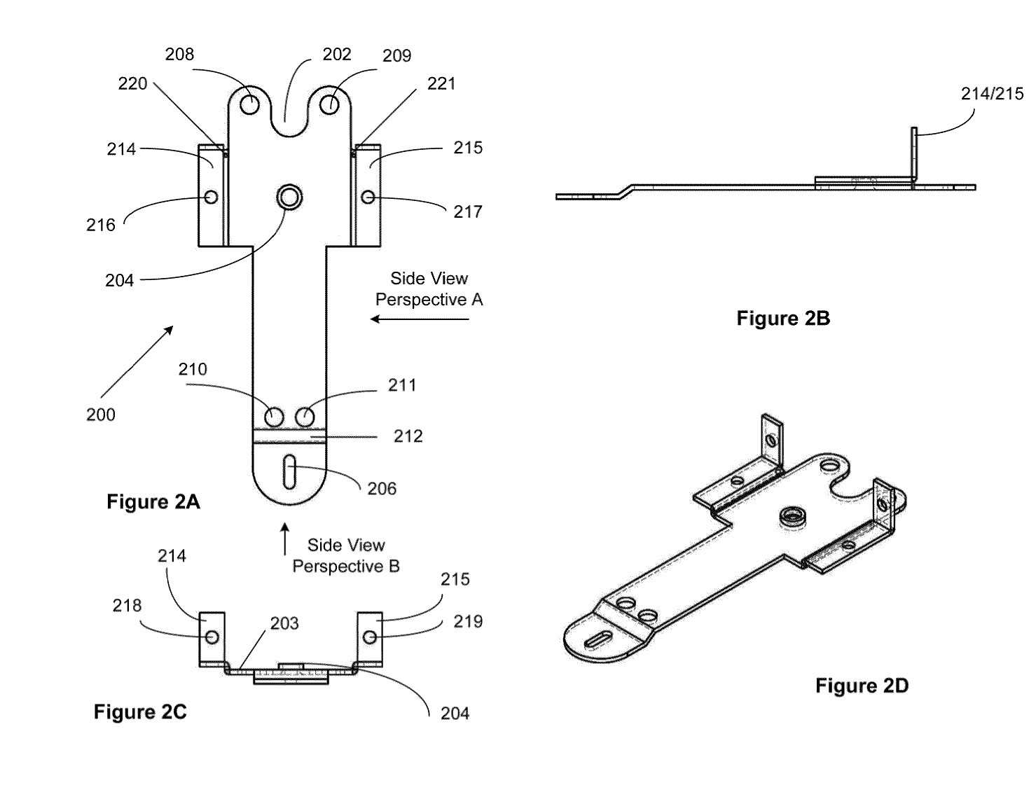

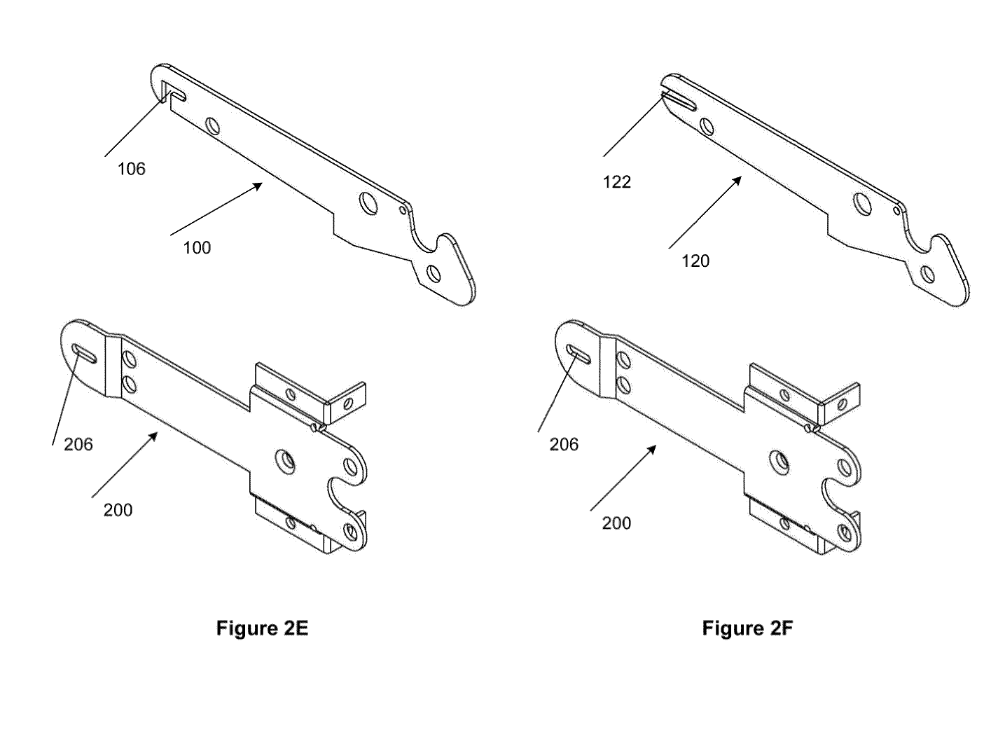

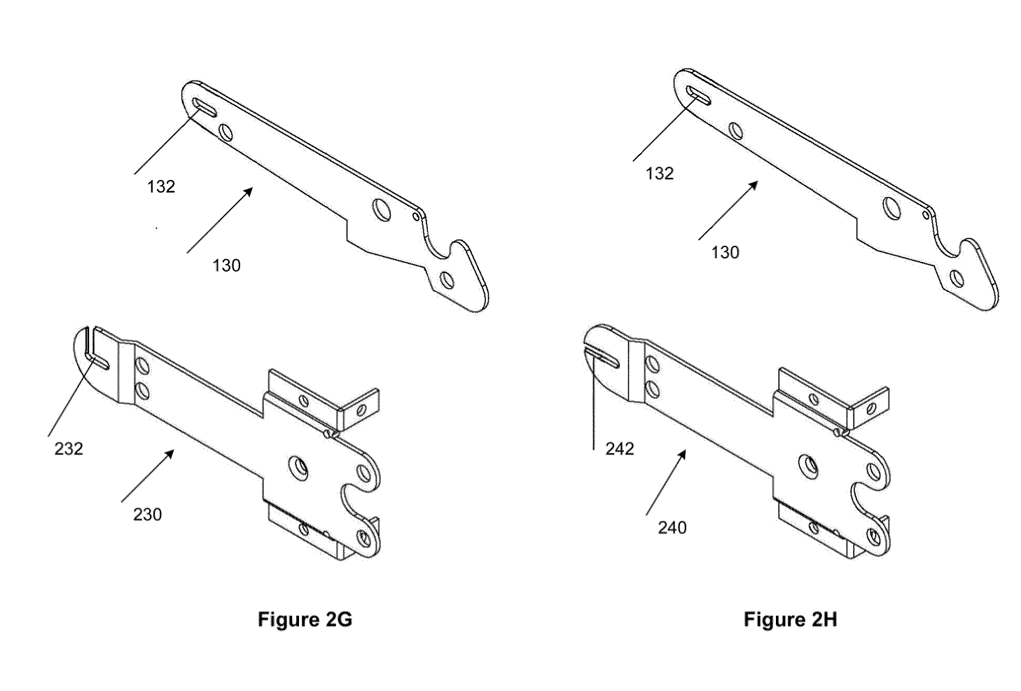

FIGS. 2A-2D illustrate a back plate of a gate latch according to embodiments of the present invention. As shown in the example of FIG. 2A, a back plate 200 includes a striker bar receiving opening 202, a pivotal support opening 204, a slider lock slot 206, a first padlock opening 208, a second padlock opening 210, a third padlock opening 209, a fourth padlock opening 211, and a spacing bend 212. The back plate 200 further includes a first L-shaped supporting structure 214, a second L-shaped supporting structure 215, a first spring opening 220, and a second spring opening 221.

FIG. 2B illustrates a side view of the back plate 200 from perspective A of FIG. 2A, where the first and second L-shaped supporting structure 214 and 215 are labeled. FIG. 2C illustrates a side view of the back plate 200 from perspective B of FIG. 2A. The first L-shaped supporting structure 214 includes a first screw opening 216 and a second screw opening 218 for securing the back plate 200 to a gate or a post. Similarly, the second L-shaped supporting structure 215 includes a third screw opening 217 and a fourth screw opening 219 for securing the back plate 200 to a gate or a post.

Note that the pivotal support opening 204 is raised above the body 203 of the back plate 200 as shown in FIG. 2C. The raised pivotal support opening is designed to match the pivotal opening 104 and to hold the pivotal latch 100 in place. In addition, the padlock openings 208 and 209 are adjacent to the striker receiving opening 202, and the padlock openings 210 and 211 are adjacent to the slider lock slot 206. FIG. 2D illustrates a 3-dimensional view of the back plate 200.

FIGS. 2E-2H illustrate various pivotal latch and back plate pairs according to embodiments of the present invention. In the example shown in FIG. 2E, the pivotal latch 100 described in FIG. 1A-1C, and the back plate 200 described in FIGS. 2A-2D are paired to work together. Note that the L-shaped slider lock opening 106 of the pivotal latch 100 and the slider lock slot 206 of the back plate 200 are aligned to each other.

FIG. 2F illustrates another pivotal latch and back plate pair combination according to embodiments of the present invention. In this example, a pivotal latch 120 and the back plate 200 are paired to work together. The pivotal latch 120 is a modified design of the pivotal latch 100 described in FIGS. 1A-1C. Specifically, the L-shaped slider lock opening 106 is modified to a horizontal slider lock opening 122; while the rest of the pivotal latch 120 is substantially similar to the pivotal latch 100. Note that the horizontal slider lock opening 122 opens to outside of the pivotal latch, which allows the pivotal latch to be released from the slider lock which in turn releases the striker bar and thus achieving opening of the gate. The horizontal slider lock opening 122 of the pivotal latch 120 and the slider lock slot 206 of the back plate 200 are aligned to each other.

FIG. 2G illustrates yet another pivotal latch and back plate pair according to embodiments of the present invention. In the example shown in FIG. 2G, a pivotal latch 130 and a back plate 230 are paired to work together. The pivotal latch 130 is a modified design of the pivotal latch 100 described in FIGS. 1A-1C. Specifically, the L-shaped slider lock opening 106 is modified to a slider lock slot 132; while the rest of the pivotal latch 130 is substantially similar to the pivotal latch 100. In addition, the back plate 230 is a modified design of the back plate 200 described in FIGS. 2A-2D. Specifically, the slider lock slot 206 is modified to be an L-shaped slider lock opening 232; while the rest of the back plate 230 is substantially similar to the back plate 200. Note that the L-shaped slider lock opening 232 opens to outside of the back plate 230, which allows the pivotal latch 130 to be released from the slider lock, which in turn releases the striker bar and thus achieving opening of the gate. The horizontal slider lock slot 132 of the pivotal latch 130 and the L-shaped slider lock opening 232 of the back plate 230 are aligned to each other.

FIG. 2H illustrates yet another pivotal latch and back plate pair according to embodiments of the present invention. In the example of FIG. 2H, a pivotal latch 130 and a back plate 240 are paired to work together. The pivotal latch 130 is similar to the one described in FIG. 2G. The back plate 240 is a modified design of the back plate 200 described in FIGS. 2A-2D. Specifically, the slider lock slot 206 is modified to be a horizontal slider lock opening 242; while the rest of the back plate 240 is substantially similar to the back plate 200. Note that the horizontal slider lock opening 242 opens to outside of the back plate 240, which allows the pivotal latch 130 to be released from the slider lock, which in turn releases the striker bar and thus achieving opening of the gate. The slider lock slot 132 of the pivotal latch 130 and the horizontal slider lock opening 242 of the back plate 240 are aligned to each other.

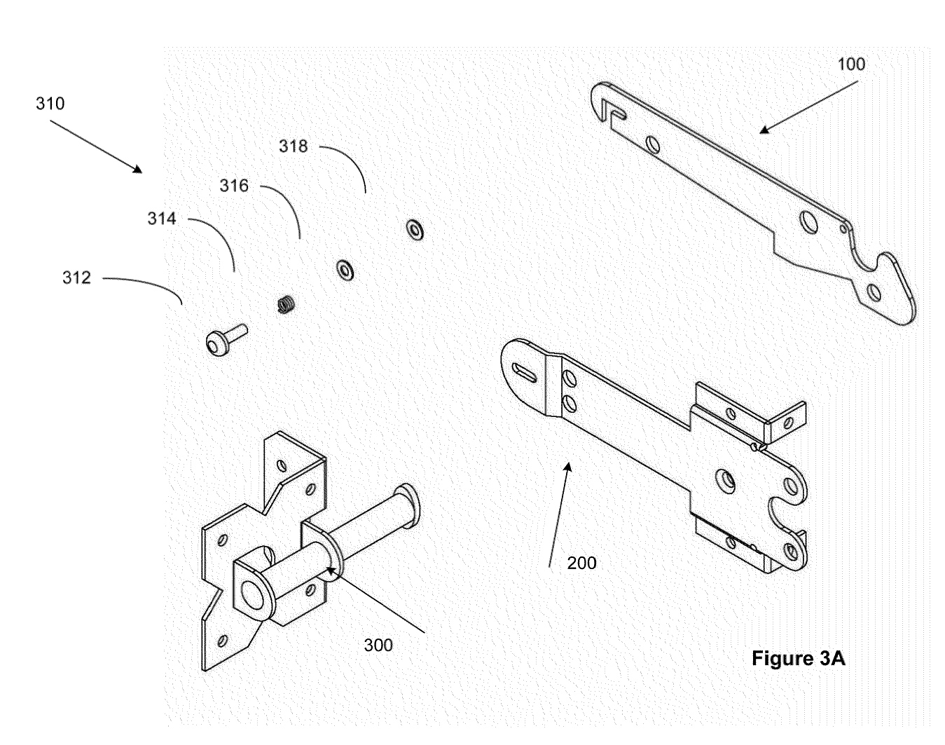

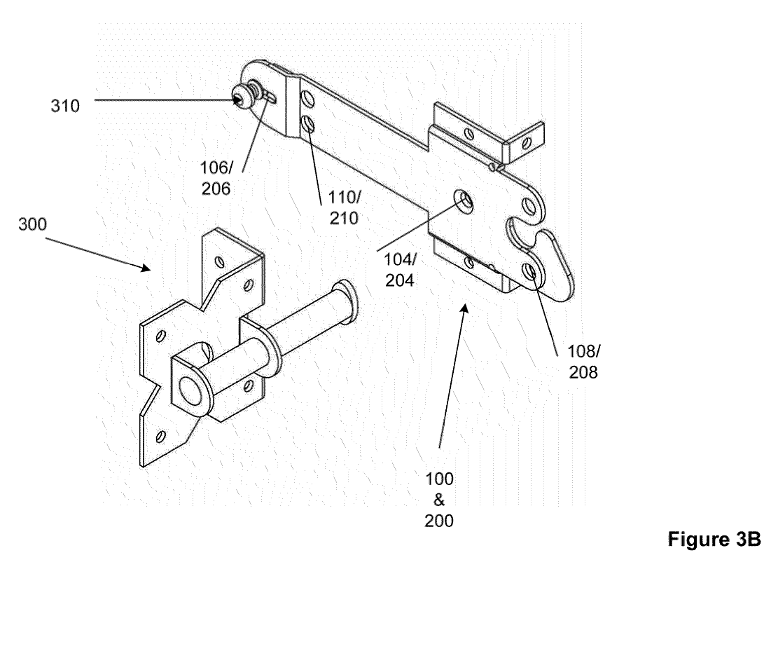

FIG. 3A-3B illustrate components and assembly of a gate latch to be operated on the left side from an inside perspective according to embodiments of the present invention. FIG. 3A shows pivotal latch 100, back plate 200, striker bar with supporting structure 300, and slider lock 310 prior to assembly. The slider lock includes a knob bolt 312, a spring 314, a first washer 316, and a second washer 318. Both the first and second washers are designed to match the knob bolt 312. Note that in the exemplary embodiments of FIGS. 3A-3B, the pivotal latch and back plate pair described in FIG. 2E is used. Person skilled in the art would appreciate that other pivotal latch and back plate pairs, such as the ones described in FIGS. 2F-2H, may also be used.

In FIG. 3B, the pivotal latch 100 is attached to the back plate 200 through the pivotal opening 104 and pivotal support opening 204. In addition, the pivotal latch 100 and the back plate 200 are held together by the slider lock 310. Note that the slider lock slot 206 of the back plate matches to the horizontal portion of the L-shaped slider lock opening 106. The first padlock opening 108 of the pivotal latch 100 matches to the first padlock opening 208 of the back plate 200; and similarly the second padlock opening 110 of the pivotal latch 100 matches to the second padlock opening 210 of the back plate. The alignment of the padlock openings 108 and 208 allows a first padlock to be inserted through these openings and thus locks the gate latch from the outside; and the alignment of the padlock openings 110 and 210 allows a second padlock to be inserted through these openings and thus locks the gate latch from the inside. Moreover, with the padlock opening pairs 108/208 and 110/210, the gate latch may be locked from both inside and outside at the same time, which provides additional security if necessary. The perspective of inside and outside is illustrated in FIGS. 4A-4D and FIGS. 7A-7D.

FIGS. 4A-4D illustrate an assembled gate latch to be operated on the left side from an inside perspective according to embodiments of the present invention. Specifically, FIG. 4A illustrates a top view of an exemplary use of the gate latch operated on the left side from an inside perspective. In this example, numeral 402 represents a gate to which the gate latch is attached to. Numeral 404 represents posts on both sides of the gate 402. Numeral 406 represents hinges of the gate 402, and numeral 408 represent fences on either side of the post 404. In this top view representation, the inside and outside of the gate 402 are labeled in FIG. 4A, and the gate 402 may be opened towards outside of the fence as indicated by the curved arrow. The gate latch is generally represented by the numerals 100, 200, 300, and 310. The gate latch is installed at the left side of the gate (from an inside perspective) and may be conveniently operated by the left hand of a user.

FIG. 4B illustrates a state of the gate latch with respect to the slider lock 310 according to embodiments of the present invention. The slider lock 310 may be used as a temporary locking device to lock the gate 402 from inside. In FIG. 4B, the slider lock 310 is at one end of the slider lock slot 206 of the back plate 200, which is also at the corner of the L-shaped slider lock opening 106 of the gate latch 100. At this position, the gate latch 100 may be released through the opening ending of the L-shaped slider lock opening 106 as shown in FIG. 4C. Thus a user may unlock the gate by pushing the gate 402 outward as indicated by the arrow shown in FIG. 4A. In FIG. 4D, the slider lock 310 is at the other end of the slider lock slot 206 (near the spacing bend 206) of the back plate 200, which is also at the closed-end of the L-shaped slider lock opening 106 of the gate latch 100. At this position, the gate latch 100 is locked and it may not be moved (or pivoted) with respect to the back plate 200. Thus, the striker bar and its supporting structure 300 is held in place by the gate latch 100 and the back plate 200, and the gate 402 is locked from inside.

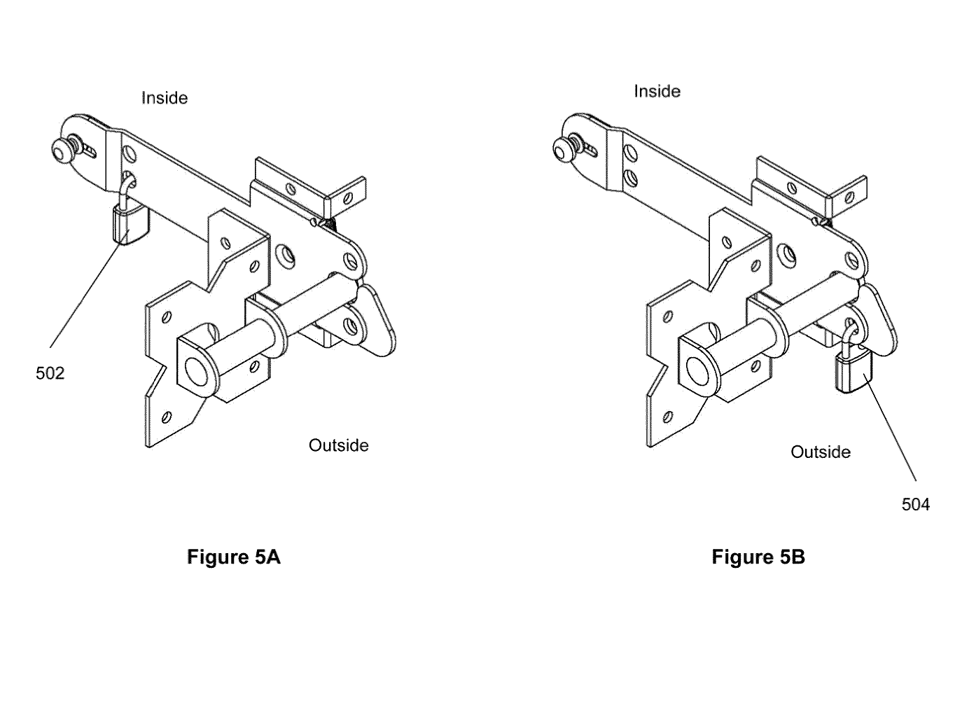

FIG. 5A-5B illustrates an assembled gate latch of FIG. 4 with padlock according to embodiments of the present invention. In the example shown in FIG. 5A, a padlock 502 is used to lock the gate latch from the inside. With the padlock 502 in locking position through the padlock openings 110 and 210 of the pivotal latch 100 and the back plate 200 respectively, neither the pivotal latch 100 nor the back plate 200 may move with respect to the padlock 502. Thus, the striker bar and its supporting structure 300 is securely held in place and the gate is locked from inside.

On the other hand, in the example shown in FIG. 5B, a padlock 504 is used to lock the gate latch from the outside. With the padlock 504 in locking position through the padlock openings 108 and 208 of the pivotal latch 100 and the back plate 200 respectively, neither the pivotal latch 100 nor the back plate 200 may move with respect to the padlock 504. Thus, the striker bar and its supporting structure 300 is securely held in place and the gate is locked from outside. In other embodiments, two padlocks, such as 502 and 504 may be used at the same time to lock the gate latch from both inside and outside of the gate 402.

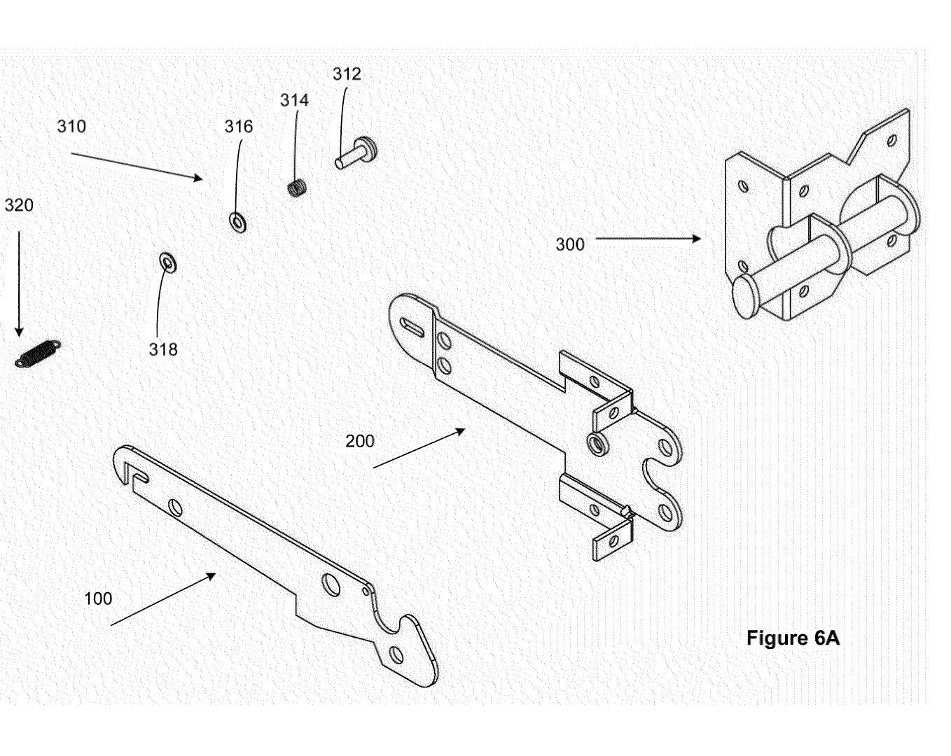

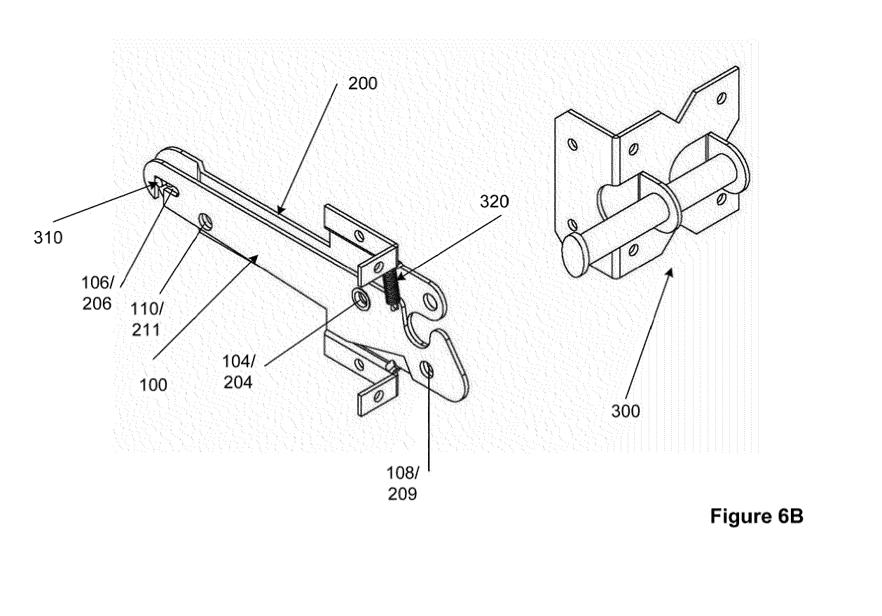

FIG. 6A-6B illustrate components and assembly of a gate latch to be operated on the right side from an inside perspective according to embodiments of the present invention. FIG. 6A shows pivotal latch 100, back plate 200, striker bar with supporting structure 300, slider lock 310, and spring 320 prior to assembly. Similar to FIG. 3A, the slider lock includes a knob bolt 312, a spring 314, a first washer 316, and a second washer 318. Both the first and second washers are designed to match the knob bolt 312. Note that in the exemplary embodiments of FIGS. 6A-6B, the pivotal latch and back plate pair described in FIG. 2E is used. Person skilled in the art would appreciate that other pivotal latch and back plate pairs, such as the ones described in FIGS. 2F-2H, may also be used.

In FIG. 6B, the pivotal latch 100 is attached to the back plate 200 through the pivotal opening 104 and pivotal support opening 204. In addition, the pivotal latch 100 and the back plate 200 are held together by the slider lock 310. Note that the slider lock slot 206 of the back plate matches to the horizontal portion of the L-shaped slider lock opening 106. The first padlock opening 108 of the pivotal latch 100 matches to the third padlock opening 209 of the back plate 200; and similarly the second padlock opening 110 of the pivotal latch 100 matches to the fourth padlock opening 211 of the back plate. The alignment of the padlock openings 108 and 209 allows a first padlock to be inserted through these openings and thus locks the gate latch from the outside; and the alignment of the padlock openings 110 and 211 allows a second padlock to be inserted through these openings and thus locks the gate latch from the inside. Moreover, with the padlock opening pairs 108/209 and 110/211, the gate latch may be locked from both inside and outside at the same time, which provides additional security if necessary. The spring 320 with hooks on both ends is held in place by the opening 112 of the pivotal latch 100 and the opening 220 of the back plate 200. The spring 320 allows the pivotal gate latch 100 to automatically return to a closed position. The perspective of inside and outside is illustrated in FIGS. 7A-7D.

FIGS. 7A-7D illustrate an assembled gate latch to be operated on the right side from an inside perspective according to embodiments of the present invention. In particular, FIG. 7A illustrates a top view of an exemplary use of the gate latch operated on the right side from an inside perspective. In this example, numeral 702 represents a gate to which the gate latch is attached to. Numeral 704 represents posts on both sides of the gate 702. Numeral 706 represents hinges of the gate 702, and numeral 708 represent fences on either side of the post 704. In this top view representation, the inside and outside of the gate 702 are labeled in FIG. 7A, and the gate 702 may be opened towards outside of the fence as indicated by the curved arrow. The gate latch is generally represented by the numerals 100, 200, 300, and 310. The gate latch is installed at the right side of the gate (from an inside perspective) and may be conveniently operated by the right hand of a user.

FIG. 7B illustrates a state of the gate latch with respect to the slider lock 310 according to embodiments of the present invention. The slider lock 310 may be used as a temporary locking device to lock the gate 702 from inside. In FIG. 7B, the slider lock 310 is at the corner of the L-shaped slider lock opening 106 of the gate latch 100, which is also at one end of the slider lock slot 206 of the back plate 200. At this position, the gate latch 100 may be released through the opening ending of the L-shaped slider lock opening 106 as shown in FIG. 7C. Thus a user may unlock the gate by pushing the gate 702 outward as indicated by the arrows shown in FIG. 7A. In FIG. 7D, the slider lock 310 is at the closed-end of the L-shaped slider lock opening 106 of the gate latch 100, which is also at the other end of the slider lock slot 206 (near the spacing bend 206) of the back plate 200. At this position, the gate latch 100 is locked and it may not be moved (or pivoted) with respect to the back plate 200. Thus, the striker bar and its supporting structure 300 is held in place by the gate latch 100 and the back plate 200, and the gate 702 is locked from inside.

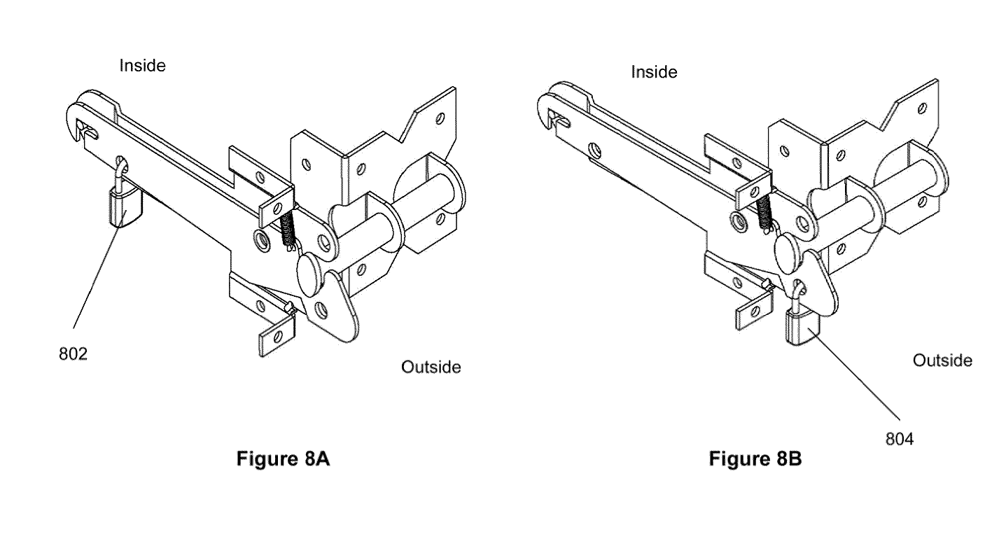

FIG. 8A-8B illustrates an assembled gate latch of FIG. 7 with padlock according to embodiments of the present invention. In the example shown in FIG. 8A, a padlock 802 is used to lock the gate latch from the inside. With the padlock 802 in locking position through the padlock openings 110 and 211 of the pivotal latch 100 and the back plate 200 respectively, neither the pivotal latch 100 nor the back plate 200 may move with respect to the padlock 802. Thus, the striker bar and its supporting structure 300 is securely held in place and the gate is locked from inside.

On the other hand, in the example shown in FIG. 8B, a padlock 804 is used to lock the gate latch from the outside. With the padlock 804 in locking position through the padlock openings 108 and 209 of the pivotal latch 100 and the back plate 200 respectively, neither the pivotal latch 100 nor the back plate 200 may move with respect to the padlock 804. Thus, the striker bar and its supporting structure 300 is securely held in place and the gate is locked from outside. In other embodiments, two padlocks, such as 802 and 804 may be used at the same time to lock the gate latch from both inside and outside of the gate 702.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A gate latch, comprising:
a pivotal latch, wherein the pivotal latch includes a pivotal opening, a first striker bar receiving opening, and a slider lock opening;
a back plate, wherein the back plate includes a pivotal support opening, a second striker bar receiving opening, and a slider lock slot;
a slider lock, wherein the slider lock is configured to slide along the slider lock slot and the slider lock opening; and
a striker bar with supporting structure, wherein the striker bar with supporting structure is used with the pivotal latch, the back plate and the slider lock to control opening and closing of a gate.

2. The gate latch of claim 1, wherein the slider lock opening is an L-shaped opening.

3. The gate latch of claim 1, wherein the slider lock opening is a horizontal opening.

4. The gate latch of claim 1, wherein the pivotal latch further comprises:
a first padlock opening adjacent to the striker bar receiving opening; and
a second padlock opening adjacent to the slider lock opening.

5. The gate latch of claim 1, wherein the back plate further comprises:
a first padlock opening adjacent to the striker bar receiving opening; and
a second padlock opening adjacent to the slider lock slot.

6. The gate latch of claim 5, wherein the back plate further comprises:
a third padlock opening adjacent to the striker bar receiving opening; and
a fourth padlock opening adjacent to the slider lock slot.

7. The gate latch of claim 1, wherein the back plate further comprises a pivotal support opening, and wherein the pivotal support opening is configured to match the pivotal opening of the pivotal latch and is configured to support the pivotal latch to pivot around the pivotal support opening.

8. The gate latch of claim 1, wherein the slider lock comprises:
a knob bolt;
a spring;
a first washer configured to match the knob bolt; and
a second washer configured to match the knob bolt.

9. The gate latch of claim 1 further comprises:
a spring having hooks on both ends for attaching the spring to the pivotal latch and the back plate respectively, the spring is configured to return the pivotal latch to a closed position automatically.

10. A gate latch, comprising:
a pivotal latch, wherein the pivotal latch includes a pivotal opening, a first striker bar receiving opening, and a slider lock slot;
a back plate, wherein the back plate includes a pivotal support opening, a second striker bar receiving opening, and a slider lock opening;
a slider lock, wherein the slider lock is configured to slide along the slider lock slot and the slider lock opening; and
a striker bar with supporting structure, wherein the striker bar with supporting structure is used with the pivotal latch, the back plate and the slider lock to control opening and closing of a gate.

11. The gate latch of claim 10, wherein the slider lock opening is an L-shaped opening.

12. The gate latch of claim 10, wherein the slider lock opening is a horizontal opening.

13. The gate latch of claim 10, wherein the pivotal latch further comprises:
a first padlock opening adjacent to the striker bar receiving opening; and
a second padlock opening adjacent to the slider lock opening.

14. The gate latch of claim 10, wherein the back plate further comprises:
a first padlock opening adjacent to the striker bar receiving opening; and
a second padlock opening adjacent to the slider lock slot.

15. The gate latch of claim 14, wherein the back plate further comprises:
a third padlock opening adjacent to the striker bar receiving opening; and
a fourth padlock opening adjacent to the slider lock slot.

16. The gate latch of claim 10, wherein the back plate further comprises a pivotal support opening, and wherein the pivotal support opening is configured to match the pivotal opening of the pivotal latch and is configured to support the pivotal latch to pivot around the pivotal support opening.

17. The gate latch of claim 10, wherein the slider lock comprises:
a knob bolt;
a spring;
a first washer configured to match the knob bolt; and
a second washer configured to match the knob bolt.

18. The gate latch of claim 10 further comprises:
a spring having hooks on both ends for attaching the spring to the pivotal latch and the back plate respectively, the spring is configured to return the pivotal latch to a closed position automatically.

19. A method of using a gate latch, comprising:
providing a pivotal latch, wherein the pivotal latch includes a pivotal opening, a first striker bar receiving opening, a slider lock opening, a first padlock opening adjacent to the striker bar receiving opening, a second padlock opening adjacent to the slider lock opening;
providing a back plate, wherein the back plate includes a pivotal support opening, a second striker bar receiving opening, a slider lock slot, .a first padlock opening adjacent to the striker bar receiving opening, a second padlock opening adjacent to the slider lock slot, a third padlock opening adjacent to the striker bar receiving opening, a fourth padlock opening adjacent to the slider lock slot, a pivotal support opening configured to support the pivotal latch to pivot around the pivotal support opening;
providing a slider lock, wherein the slider lock is configured to slide along the slider lock slot and the slider lock opening; and
providing a striker bar with supporting structure;
assembling the pivotal latch, the back plate, the slider lock, and the striker bar with supporting structure to form a gate latch, where in the gate latch is configured to control opening and closing of a gate.

20. The method of claim 19, wherein the assembling includes forming a gate latch to be located on the left side of a gate from an inside perspective, comprising:
aligning the pivotal opening of the pivotal latch to the pivotal support opening of the back plate;
aligning the first padlock opening of the pivotal latch to the first padlock opening of the back plate;
aligning the second padlock opening of the pivotal latch to the second padlock opening of the back plate; and
aligning the slider lock opening of the pivotal latch to the slider lock slot of the back plate.

21. The method of claim 20, further comprising unlocking the gate latch by:
sliding the slider lock to the back end of the slider lock slot; and
lifting the pivotal latch to release the striker bar.

22. The method of claim 20, further comprising locking the gate latch by at least one or more of the following three ways:
sliding the slider lock to the front end of the slider lock slot;
using a first padlock through the first padlock opening of the pivotal latch and the first padlock opening of the back plate; and
using a second padlock through the second padlock opening of the pivotal latch and the second padlock opening of the back plate.

23. The method of claim 19, wherein the assembling includes forming a gate latch to be located on the right side of a gate from an inside perspective, comprising:
aligning the pivotal opening of the pivotal latch to the pivotal support opening of the back plate;
aligning the first padlock opening of the pivotal latch to the third padlock opening of the back plate;
aligning the second padlock opening of the pivotal latch to the fourth padlock opening of the back plate; and
aligning the slider lock opening of the pivotal latch to the slider lock slot of the back plate.

24. The method of claim 23, further comprising unlocking the gate latch by:
sliding the slider lock to the back end of the slider lock slot; and
lifting the pivotal latch to release the striker bar.

25. The method of claim 23, further comprising locking the gate latch by at least one or more of the following three ways:
sliding the slider lock to the front end of the slider lock slot;
using a first padlock through the first padlock opening of the pivotal latch and the third padlock opening of the back plate; and
using a second padlock through the second padlock opening of the pivotal latch and the fourth padlock opening of the back plate.
